(19) United States
(12) Patent Application Publication
(10) Pub. No.: US 2005/0243032 A1
(43) Pub. Date: Nov. 3, 2005

(54) Power line layout for electroluminescent display

(76) Inventor: Kuo-Sheng Lee, Yongkang City (TW)

Correspondence Address: David I. Roche;BAKER & McKENZIE, 130 E. Randolph Drive, Chicago, IL, 60601, US

(21) Appl. No.: 10/834,705

(22) Filed: Apr. 29, 2004

(51) Int. Cl. G09G 3/30

(52) U.S. Cl. 345/76

(57) ABSTRACT

In a pixel array of an electroluminescent display, a power line arrangement includes a mesh of interlacing power lines running along perpendicular directions. The power lines intersect at connection nodes provided for each pixel. The interlacing power lines thereby prevents a power bias due to the selective illumination of the pixels.

### BACKGROUND OF THE INVENTION

1. Field of the Invention

This invention relates to the field of electroluminescent displays, and more particularly to a power line arrangement for a pixel array of an electroluminescent display.

2. Description of the Related Art

Electroluminescent displays have recently attracted many researches and developments in the field of emissive display technology. Compared to other types of emissive displays such as the plasma displays, the electroluminescent display provide many advantages such as a lower power consumption, a reduced size, and high image brightness. An electroluminescent display system conventionally includes a mesh of scan and data lines that define an array of pixels in each of which is coupled one light-emitting device. The light-emitting device particularly can be an organic light-emitting device (OLED), and is usually driven by a driving circuit associated to each pixel.

FIG. 1A is a schematic view of a conventional pixel circuitry implemented in an electroluminescent display known in the art. The pixel circuit 110 includes a light-emitting device 118 and a driving circuit comprised of two transistors 112, 114 and a storage capacitor 116. The transistors 112, 114 can be any type of transistors, such as thin film transistors or the like. The transistor 114 has a gate coupled with a scan line 102, while its source and drain are coupled between a data line 104 and one electrode terminal of the storage capacitor 116. The other electrode terminal of the storage capacitor 116 is coupled with a power line 122 at a power voltage V_{dd}. When the pixel 110 is selected, the transistor 114 operates to charge the storage capacitor 116 with a data signal DATA containing an image information.

The drain and the source of the transistor 112 couple from the power voltage V_{dd} via the light-emitting device 118 to the ground voltage Vₛₛ. The storage capacitor 116 is coupled between the gate and the drain of the transistor 112. The transistor 112 operates as a driving transistor that delivers an electric current to the light-emitting device 118 upon the presence of the data signal voltage charged in the storage capacitor 116.

FIG. 1B is a schematic view illustrating the operation of a conventional pixel array of an electroluminescent display. The pixel array 100 includes the mesh of scan and data lines 102, 104 defining an array of pixels 110, and power lines 122 running along the direction of the scan lines 104. A scanning driver integrated circuit 162 is coupled with the scan lines 102, while a data driver integrated circuit 164 is coupled with the data lines 104. All the power lines 122 are further commonly coupled with a power bus 150.

FIG. 1B shows an exemplary display test in which the pixel array 100 system is operated to display a dark area 182 in the center of a white background area 184. The dark area 182 corresponds to an area where the light-emitting devices are turned off, while the surrounding white background area 184 encompasses turned-on light-emitting devices. As shown in FIG. 1B, areas 186 of the white background at two sides of the dark area 182 usually appear with a brightness different from other areas of supposedly similar white background.

FIG. 1C is a circuit model simulating a voltage drop observable in one pixel of the conventional electroluminescent display. Before it effectively reaches one pixel, an electric current typically flows through a circuitry outside the pixel, which results in a dissipation. This dissipation can be characterized by a voltage drop caused by one resistor 130 coupled between the node X and the power voltage potential V_{dd}. If it is supposed that Vₛₛ is the ground, the voltage drop V_{drop} due to resistance dissipation can be expressed at the node X as:
Vₓ=V_{dd}−V_{drop} (I);

For a pixel A located on a row 122b where all the pixels are illuminated, the voltage drop V_{drop} can be expressed as follows:
V_{drop}=I×N×R (II);

wherein I is the electric current delivered to each pixel of the row 122b, N is the total number of pixels on the row 122b, and R is the resistance of the resistor 130.

In contrast for a pixel B located on a row 122a where if only half the number of pixel (N/2) are illuminated, the voltage drop V_{drop} is expressed differently as follows:
V_{drop}=I×(N/2)×R (III).

The foregoing simulation shows that the voltage drop due to resistance dissipation depends on the number of pixels illuminated on the same row. As a result, the effective power voltage available for the driving circuit fluctuates and causes undesirable brightness degradation.

Therefore, there is presently a need for an electroluminescent display, and more particularly for a pixel array structure of electroluminescent display that can overcome the prior problems.

### SUMMARY OF THE INVENTION

The application describes a power line arrangement for an electroluminescent display.

In one embodiment, the electroluminescent display comprises a mesh of scan lines and data lines defining an array of pixels, a mesh of interlacing power lines, one or more light-emitting devices in each pixel, and a driving circuit coupled in each pixel with the one or more light-emitting device, one scan line, one data line, and one power line, respectively. The driving circuit is operable to deliver an electric current to the light-emitting device in response to a scan signal and a data signal received through the scan and data lines, respectively.

In some embodiments, the mesh of power lines includes power lines intersecting at one or more connection node. In some variant embodiment, the mesh of power lines includes power lines intersecting at one connection node corresponding to each pixel.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1A is a schematic view of a conventional pixel circuitry implemented in an electroluminescent display;

FIG. 1B is a schematic view of a conventional pixel array implemented in an electroluminescent display;

FIG. 1C is a circuit model simulating a voltage drop observable in one pixel of the conventional electroluminescent display;

FIG. 2A is a schematic view of a pixel array implemented in an electroluminescent display according to an embodiment of the invention;

FIG. 2B is a schematic view of a pixel circuitry implemented in an electroluminescent display according to an embodiment of the invention; and

FIG. 2C is a schematic view of a pixel array according to an embodiment of the invention, exemplary operated in a display test mode.

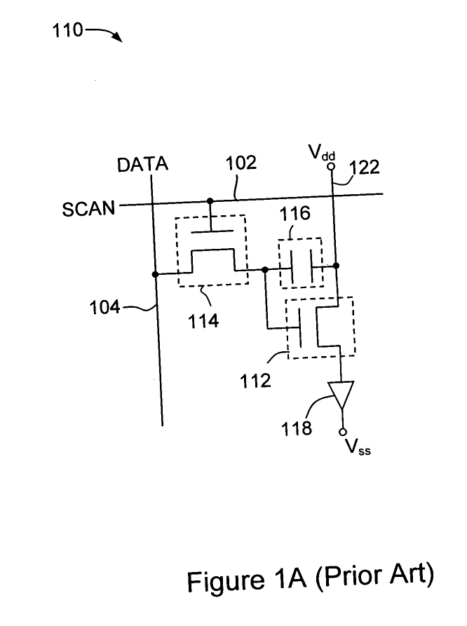

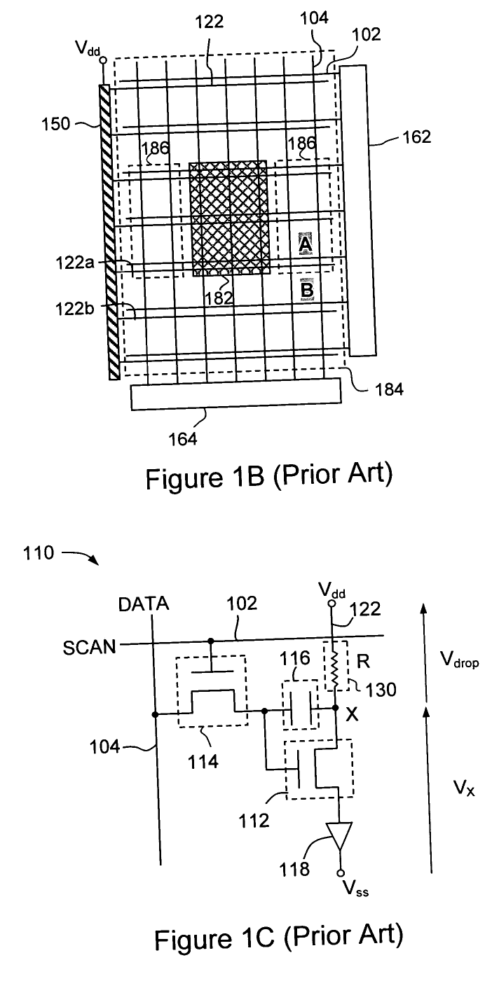

### DETAILED DESCRIPTION OF THE EMBODIMENT(S)

The application describes a power line arrangement that, being implemented in an electroluminescent display, can overcome the problems of the prior art. The electroluminescent display described herein can be an active matrix organic light emitting diode (AMOLED) display.

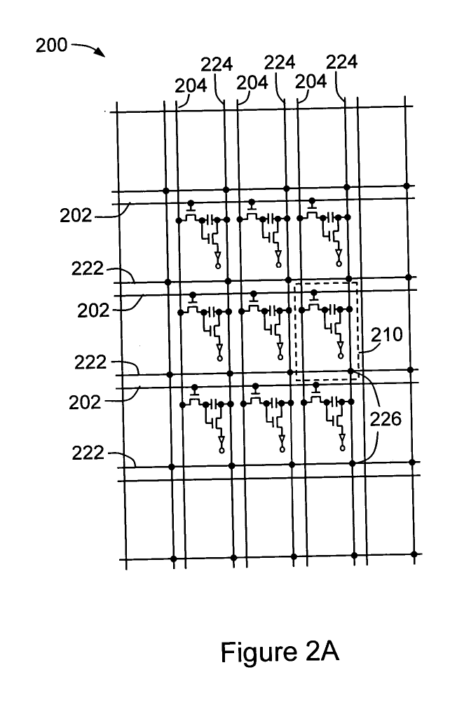

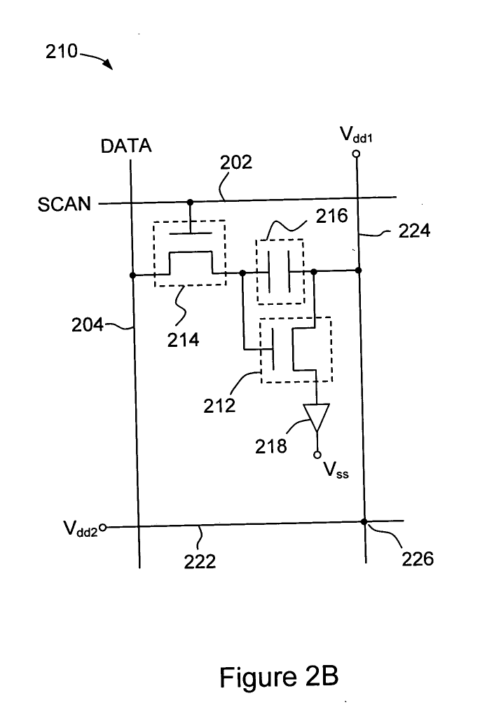

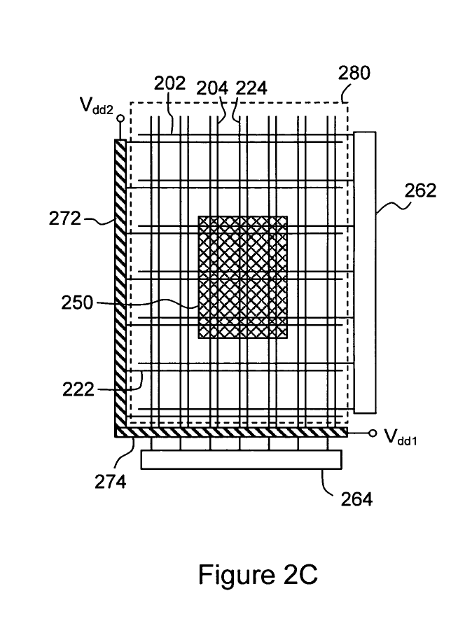

FIG. 2A is a schematic view of a pixel array implemented in an electroluminescent display according to an embodiment of the invention. The pixel array 200 includes a mesh of scan lines 202 and data lines 204 that define a plurality of pixels 210, and a mesh of interlacing power lines 222, 224. The scan lines 202 deliver scan signals SCAN to select the pixels to be activated, while the data lines 204 deliver data signals DATA containing an image information to be reflected by the illumination of the selected pixels.

FIG. 2B is a schematic diagram of approximately one pixel area of the pixel array illustrated in FIG. 2A. One pixel 210 includes a first transistor 212, a second transistor 214, a storage capacitor 216, and one or more light-emitting device 218. The transistors 212, 214 can be NMOS or PMOS thin film transistors. In the illustrated implementation, the second transistor 214 has a gate coupled with a scan line 202, while its source and drain are coupled between a data line 204 and one electrode terminal of the storage capacitor 216. The other electrode terminal of the storage capacitor 216 is coupled with the power line 224 at a first power voltage V_{dd1}. When the pixel 210 is selected, the second transistor 214 operates as a switch thin film transistor to charge the storage capacitor 216 with a data signal DATA containing an image information.

The drain and the source of the first transistor 212 couple from the power first voltage V_{dd1} via the light-emitting device 218 to the ground voltage Vₛₛ. The storage capacitor 216 is coupled between the gate and the drain of the first transistor 212. The light-emitting device 218 can be an organic light-emitting device. The first transistor 212 operates as a driving transistor that delivers an electric current to the light-emitting device 218 according to the level of the data signal charged in the storage capacitor 216.

It is understood that the foregoing embodiment depicts only one specific example of pixel circuit, and many pixel driving circuits can be practically implemented with the power line layout according to the invention as detailed hereafter.

As illustrated in FIG. 2A-2B, the pixel array 200 includes a mesh of interlacing power lines 222, 224 at first and second power voltage V_{dd2}, V_{dd1}, respectively. In the illustrated embodiment, the first power lines 222 exemplary run parallel to the scan lines 202 along a horizontal direction, while the second power lines 224 run parallel to the data lines 204 along a vertical direction. The power lines 222, 224 intersect with one another at connection nodes 226, so that V_{dd1}=V_{dd2}. In an embodiment, at least one connection node 226 intersection of the power lines 222, 224 can be provided corresponding to each pixel 210 of the pixel array 200. The mesh of interlacing power lines 222, 224 can reduce the dissipation caused by circuit resistance external to each pixel. Undesirable power bias due to the selective illumination of the pixels 210 can be thereby prevented.

FIG. 2C is a schematic view of a display pattern obtained by operating an electroluminescent display constructed according to an embodiment according to the invention. The display system is operated to exhibit a dark area 250 in the center of a white background display area 280. The display area 280 is formed by a mesh of scan and data lines 202, 204 that defines an array of pixels 210, as described above. A scanning driver intergrated circuit 262 and a data driver integrated circuit 264 respectively couple with the scan and data lines 202, 204 to deliver the signals SCAN and DATA to the pixels 210. Power buses 272, 274 further respectively couple with the power lines 222, 224 to provide the power voltages V_{dd2}, V_{dd1}.

In the electroluminescent display, displaying the dark area 250 is achieved via turning the corresponding pixels to an extinguished state, i.e. the light-emitting devices are turned off, while the other pixels of the white background are lighted on. The mesh of power lines 222, 224 contributes to substantially reduce the power dissipation due to circuit-resistance, and a uniform power current can be thereby inputted to the pixels to be illuminated to the same state.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Additionally, structures and functionality presented as discrete components in the exemplary configurations may be implemented as a combined structure or component. These and other variations, modifications, additions, and improvements may fall within the scope of the invention as defined in the claims that follow.

1. An electroluminescent display, comprising:
a mesh of scan lines and data lines defining an array of pixels;
a mesh of interlacing power lines;
one or more light-emitting device in each pixel; and
a driving circuit coupled in each pixel with the one or more light-emitting device, one scan line, one data line, and one power line, respectively, wherein the driving circuit is operable to deliver an electric current to the one or more light-emitting device upon receiving a scan signal and a data signal through the scan and data lines, respectively.

2. The electroluminescent display of claim 1, wherein the mesh of power lines includes first power lines running parallel along a first direction and second power lines running parallel along a second direction intersecting the first direction.

3. The electroluminescent display of claim 1, wherein the mesh of power lines include first power lines at a first power voltage and second power lines at a second power voltage.

4. The electroluminescent display of claim 3, wherein the first power voltage is approximately equal to the second power voltage.

5. The electroluminescent display of claim 1, wherein the mesh of power lines includes power lines intersecting at one or more connection node.

6. The electroluminescent display of claim 1, wherein the mesh of power lines includes power lines intersecting at one connection node corresponding to each pixel.

7. The electroluminescent display of claim 1, wherein the driving circuit comprises:
a storage capacitor;
a switch element coupled between one scan line and one data line, wherein the switch element is operable to charge the storage capacitor with a data signal upon receiving a scan signal; and
a driving element coupling the one or more light-emitting device to at least one power line, wherein the driving element is operable by means of the data signal charged in the storage capacitor to deliver an electric current to the one or more light-emitting device.

8. The electroluminescent display of claim 7, wherein the switch element includes a switching thin film transistor.

9. The electroluminescent display of claim 7, wherein the driving element includes a driving thin film transistor.

10. The electroluminescent display of claim 1, wherein the one or more light-emitting device include one or more organic light-emitting devices.

11. The electroluminescent display of claim 1, further comprising:
a scanning driver integrated circuit coupled with the scan lines; and
a data driver integrated circuit coupled with the data lines.

12. The electroluminescent display of claim 1, further comprising a first power bus coupled with a plurality of first power lines running along a first direction, and a second power bus coupled with a plurality of second power lines running along a second direction.
